(19) United States
(12) Patent Application Publication
(10) Pub. No.: US 2020/0171713 A1
(43) Pub. Date: Jun. 4, 2020

(54) LUBRICANT-INFUSED MOLDS AND USES THEREOF

(71) Applicant: McMaster University, Hamilton (CA)

(72) Inventors: Tohid Didar, Dundas (CA); Martin Villegas, Hamilton (CA); Amid Shakeri, Hamilton (CA); Zachary Cetinic, Toronto (CA)

(21) Appl. No.: 16/204,165

(22) Filed: Nov. 29, 2018

(51) Int. Cl. B29C 33/60; B33Y 80/00; B29C 37/00; B29C 41/02

(52) U.S. Cl. CPC B29C 33/60; B33Y 80/00; B29K 2083/00; B29C 41/02; B29C 2037/92; B29C 37/00

(57) ABSTRACT

The present application relates to lubricant-infused molds such as omniphobic lubricant-infused molds and uses thereof, for example, in processes for fabricating molded objects such as microfluidics devices. Such processes can comprise coating a mold with a layer comprising a lubricant-tethering group to obtain a tether-coated mold, depositing a lubricant on the tether-coated mold to obtain a lubricant-infused mold (LIM), depositing a molded object precursor into the LIM and solidifying to obtain the molded object, and removing the molded object from the LIM.

### FIELD

The present application relates to lubricant-infused molds such as omniphobic lubricant-infused molds and uses thereof, for example, for fabricating molded objects such as microfluidics devices.

### BACKGROUND

In recent decades, microfluidic devices have become increasingly popular in the field of biomedical engineering due, for example, to their high throughput, automation capabilities, and/or their low-cost in fabrication and/or operation.^{1,2} Among the different materials used to fabricate microfluidic devices for rapid prototyping, polydimethylsiloxane (PDMS) is a widely used, inexpensive, polymeric material; its physicochemical properties, short curing time and innocuous fabrication procedure have made it the standard in the production of polymeric microfluidic devices. A variety of PDMS microfluidic devices have been manufactured for medical applications, including cell sorting, gradient concentration generation, point-of-care diagnostics, and organs-on-chips.^{3,4,5,6}

Current molding fabrication processes require the costly production of molds, for example, photolithography of glass or silicon for microfabrication; or a combination of macro and micro-machining techniques for the fabrication of steel, graphite or other metallic molds. Many high-resolution devices are prototyped by casting PDMS into photolithographically manufactured molds. Photolithography is a popular method of creating high-resolution casting molds; however, photolithographic techniques typically are time-intensive, laborious, and require access to clean-room facilities and specialized training. Therefore, there remains a need for an alternative method to streamline device prototyping.

More inexpensive molds have been tested, however, these molds usually result in roughened finishes on the casted material, which may require additional machining or buffer to obtain a smoother surface. 3D printing, a growing method for rapid fabrication, is one option for an economical substitution for the production of microfluidic devices since it can, for example, produce functional molds in a short time span with minimal fabrication steps.

There are many 3D printing technologies used for the rapid prototyping of microfluidic devices including fuel deposition modeling, selective laser sintering (SLS) and multi-jet modeling (MJM).⁷ However, one of the disadvantages of using 3D printed molds is the rough surface topologies and low resolutions that accompany the production of the devices.

While the use of a 3D printed mold to cast PDMS microfluidic devices has been previously reported, methods to improve 3D printed surface topology have not been thoroughly researched.^{8,9} The surface topology of a fabricated mold using the MJM printing method has high variability and roughness. This increases the difficulty of creating smooth, defined microfluidic pieces from the mold, as shown in previous studies.¹⁰ Prior to the present studies, there has not been a report that addresses the problem with 3D printed surface mold topology. While smoother surface topology can be achieved using the photolithographic methods discussed above, this method is often economically unfeasible, inaccessible, and involves a lengthy prototyping process.

The use of lubricant-infused coatings have been explored as a way of creating omniphobic slippery surfaces, which have been used in applications including blood coagulation prevention, anti-biofouling, and anti-icing.^{11,12,13} These surfaces are usually fabricated from superhydrophobic surfaces (contact angles above 150 degrees)¹⁴ conjugated with a compatible lubricant to obtain low sliding angles (under 10 degrees), for both aqueous and organic solvents.^{15,16,17} Omniphobic coatings have been fabricated by lubricating surfaces with fluorinated groups.^{17,18,19} Blin & Stébé, showed that fluorinated lubricants can infiltrate and bind to fluorosurfactants while oil and polar solutions cannot.²⁰ However, to the best of the Applicant's knowledge, the application of omniphobic lubricant-infused coatings on casting molds for improving the surface quality of microfluidic devices has not previously been reported.

### SUMMARY

A new application of lubricant-infused coatings for producing smooth surfaces cast on rough molds is described herein. A fabrication technique based on using an omniphobic lubricant-infused mold (OLIM) was used to create PDMS devices with significantly lower surface roughness than those created from a neat 3D printed mold. By coating fluoroalkylsilanes onto the 3D master negative mold, a lubricant can be “locked” to the mold, which can then be used to create smooth PDMS positive channeled molds. This, in turn, can be used to cast the next series of microfluidic devices containing smooth channels. The channels were qualitatively smoother and this was confirmed through quantitative profilometric analysis, simulation and imaging live cells inside the device. Utilizing this fabrication technology, the surface roughness of the PDMS microfluidic channels was reduced by an order of magnitude, from about 2 μm to about 0.2 μm. The PDMS device created from the OLIM had roughness comparable to casting PDMS on smooth cell culture petri dishes. This technique can be used to further reduce the costs associated with rapidly producing smooth PDMS, microfluidic devices. The ability to produce smooth microfluidic devices from low-resolution, inexpensive 3D printed molds, may, for example, help decrease barriers for the manufacturing of microfluidic devices and advance research in microfluidic device technology. Obtaining smooth products from rough surfaces can reduce the cost of fabrication of the mold. The use of a lubricant-infused mold e.g. an OLIM may also have advantages in that it can reduce adhesion forces between the mold and casted material, allowing for faster and effortless delamination processes. In addition, it may, for example, mitigate the use of post-processing to obtain a smooth surface finish on the cured material.

Accordingly, the present application includes a process for fabricating a molded object, the process comprising:
coating a mold with a layer comprising a lubricant-tethering group to obtain a tether-coated mold;
depositing a lubricant on the tether-coated mold to obtain a lubricant-infused mold (LIM);
depositing a molded object precursor into the LIM and solidifying to obtain the molded object; and
removing the molded object from the LIM.

In an embodiment, the layer comprising the lubricant-tethering group and the lubricant deposited thereon form an omniphobic surface and the lubricant-infused mold is an omniphobic lubricant-infused mold (OLIM).

The present application also includes a lubricant-infused mold (LIM), the LIM comprising:
a mold;
a layer comprising a lubricant-tethering group coated on the mold; and
a lubricant tethered to the layer comprising the lubricant-tethering group.

In an embodiment, the lubricant-infused mold is an omniphobic lubricant-infused mold (OLIM) and the layer comprising the lubricant-tethering group and the lubricant tethered to the layer form an omniphobic surface.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF THE DRAWINGS

The embodiments of the application will now be described in greater detail with reference to the attached drawings in which:

FIG. 1 is a schematic diagram showing an overview of fabrication processes used to create PDMS microfluidic channels from 3D printed molds. The top flowchart shows the regular fabrication technique without any modification to the 3D printed mold wherein the final PDMS device is shown in medium grey with a rough surface topology. The middle flowchart shows an exemplary modified fabrication technique using a positive 3D printed OLIM, wherein the final PDMS channel is shown in medium grey with a smooth exterior and rough interior channels. The bottom flowchart shows an exemplary smooth channeled PDMS fabrication technique wherein PDMS is cast on a negative 3D printed OLIM and cured, producing a smooth positive PDMS mold which is then silanized and another layer of PDMS is cast upon it, creating the smooth channeled, microfluidic device shown in medium grey at the lower left.

FIG. 2 shows optical microscope images showing PDMS and microfluidic channels; PDMS, microfluidic channel fabricated using a positive 3D printed mold with no coating (upper left); microfluidic channel fabricated using a positive, lubricated 3D printed mold (upper right); an exemplary microfluidic channel fabricated using a positive 3D printed OLIM (lower left); and exemplary PDMS, microfluidic channels fabricated by casting on the smooth channeled, silanized, PDMS mold obtained from a negative 3D printed OLIM (lower right). Scale bar represents 200 μm.

FIG. 3 shows contact angle images for: a 3D printed mold (upper left); a silanized 3D printed mold (upper right); an exemplary smooth PDMS device (lower left); and an exemplary silanized smooth PDMS device (lower right).

FIG. 4 shows contact angles for, from left to right: a 3D printed mold, a silanized 3D printed mold, an exemplary smooth PDMS device and an exemplary silanized smooth PDMS device using a 2 μL water droplet (upper plot); and shows the sliding angle of exemplary lubricated mold and PDMS devices measured using a 5 μL water droplet (lower plot). Data are displayed as mean and s.e.m. with sample sizes of n=5 for contact angle and n=15 for sliding angle measurements.

FIG. 5 is a plot showing the average roughness (Ra) (μm) for the 3D printed mold and PDMS devices cast on: a positive 3D printed mold, an exemplary positive 3D printed OLIM, an exemplary positive rough PDMS mold, an exemplary positive smooth PDMS mold, and a flat cell culture petri-dish as a smooth reference surface. Measurements were obtained by comparing points from within the channel of each device. Statistical significance is shown as ‘N. S.’ for non-significant p-value >0.05 and ‘**’ indicates a highly significant difference between the rough and smooth groups with p-value <0.01. Data are displayed as mean and s.e.m with sample size n=15.

FIG. 6 shows exemplary scanning electron microscopy (SEM) images displaying the surface roughness of the fabricated PDMS microchannel cast on: a positive 3D printed mold (top image), an exemplary positive 3D printed OLIM (second image from top), and an exemplary final device cast on a smooth positive PDMS mold obtained from a negative 3D printed OLIM at 200× magnification (second image from bottom) and 5000× magnification (bottom image). Scale bars represent 50 μm on top three images, and 5 μm on bottom image.

FIG. 7 shows a representation of rectangular cross-section microchannels with two different rough surfaces at the bottom face of the channels designed by COMSOL Multiphysics 5.3 (upper left and right images); and velocity magnitude variations of two microchannels with different roughness's along the lateral cut-line at the height of 10 μm above the rough surfaces' mean plane (lower left and right images). Sₐ indicates the roughness parameter based on arithmetical mean height calculation. The black dashed lines in the upper left and right images show the position of the lateral cut-line along which the shear rate and velocity magnitude variations were measured and plotted. The cut-line is located at the mid-length of the channels.

FIG. 8 shows simulation results of microfluidic channels with two different roughness at the bottom faces of channels; a slice representation of velocity distribution along the width and length of the microchannels with the roughness numbers of 2 μm (upper images) and 0.2 μm (lower images).

FIG. 9 shows simulation results of microfluidic channels with two different roughness at the bottom faces of channels; volumetric shear rate distribution of the two microchannels with the roughness numbers of 2 μm (upper) images) and 0.2 μm (lower images). Each inset figure represents the shear rate at the bottom face of the respective microchannels.

FIG. 10 shows simulation results of microfluidic channels with two different roughness at the bottom faces of channels; slice representation of shear rate across the two microchannels with the roughness numbers of 2 μm (upper image) and 0.2 μm (lower image).

FIG. 11 shows simulation results of microfluidic channels with two different roughness at the bottom faces of channels with the roughness numbers of 2 μm (upper plot) and 0.2 μm (lower plot); shear rate variations along a lateral cut-line (as shown in FIG. 7, upper images) plotted at the mid-length of microchannels and at the height of 5 μm above the rough surfaces' mean plane.

FIG. 12 shows simulation results of microfluidic channels with two different roughness at the bottom faces of channels with the roughness numbers of 2 μm (upper plot) and 0.2 μm (lower plot); shear rate magnitude fluctuations along the same cut-line as shown in FIG. 7, upper images but plotted at the height of 10 μm (half of the microchannel's height).

FIG. 13 shows simulation results of microfluidic channels with two different roughness at the bottom faces of channels with the roughness numbers of 2 μm (upper plot) and 0.2 μm (lower plot); velocity magnitude variations along the same lateral cut-line as shown in FIG. 7, upper images at the height of 5 μm.

FIG. 14 shows photographs of an exemplary bonded device (upper) and dynamic usage (lower). Images of the exemplary final device are perfused with dyed water.

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this application, the singular forms “a”, “an” and “the” include plural references unless the content clearly dictates otherwise. For example, an embodiment including “a lubricant” should be understood to present certain aspects with one lubricant or two or more additional lubricants.

In embodiments comprising an “additional” or “second” component, such as an additional or second lubricant, the second component as used herein is chemically different from the other components or first component. A “third” component is different from the other, first, and second components, and further enumerated or “additional” components are similarly different.

The term “and/or” as used herein, means that the listed items are present, or used, independently or in combination. In effect, this term means that “at least one of” or “one or more” of the listed items is used or present.

The term “omniphobic” as used herein in respect to a surface refers to a surface with low wettability for both polar and nonpolar liquids.

The term “hydrophobic” as used herein refers to a surface with low wettability for polar liquids.

The term “oleophobic” as used herein refers to a surface with low wettability for nonpolar liquids.

The term “low wettability” as used herein in respect to a polar liquid means a water contact angle greater than 90° and as used herein in respect to a nonpolar liquid means an oil contact angle greater than 90°.

The term “perfluorocarbon oil” as used herein refers to a compound comprising carbon, fluorine and optionally one or more heteroatoms that is a liquid at ambient temperature (e.g. a temperature of about 4° C. to about 40° C. or about 25° C.).

The term “perfluorocarbon group” as used herein refers to a functional group comprising carbon, fluorine and optionally one or more heteroatoms.

The term “perfluoroalkane” as used herein means a straight or branched chain, saturated alkane, in which each hydrogen atom has been replaced with a fluorine atom. In some embodiments of the present application the number of carbon atoms that are possible in a referenced perfluoroalkane are indicated by the numerical prefix “Cₙ₁₋ₙ₂”. For example, the term C₅₋₁₂uperfluoroalkane means a perfluoroalkane having 5, 6, 7, 8, 9, 10, 11 or 12 carbon atoms.

The term “perfluoroalkyl group” as used herein, whether it is used alone or as part of another group, means a straight or branched chain, saturated alkyl group, in which each hydrogen atom has been replaced with a fluorine atom. In some embodiments of the present application the number of carbon atoms that are possible in a referenced perfluoroalkyl group are indicated by the numerical prefix “Cₙ₁₋ₙ₂”. For example, the term C₃₋₁₂perfluoroalkyl means a perfluoroalkyl group having 3, 4, 5, 6, 7, 8, 9, 10, 11 or 12 carbon atoms.

The term “perfluoroalkylene group” as used herein, whether it is used alone or as part of another group, means a straight or branched chain, saturated alkylene group, in which each hydrogen atom has been replaced with a fluorine atom.

The term “perfluorohaloalkane” as used herein means a straight or branched chain, saturated haloalkane (i.e. an alkane that has been substituted with at least one halo substituent e.g. bromo, in which case the perfluorohaloalkane is referred to herein as a “perfluorobromoalkane”), in which each hydrogen atom has been replaced with a fluorine atom. In some embodiments of the present application the number of carbon atoms that are possible in a referenced perfluorohaloalkane e.g. a perfluorobromoalkane are indicated by the numerical prefix “Cnₙ₁₋ₙ₂”. For example, the term C₅₋₁₂uperfluorobromoalkane means a perfluorobromoalkane having 5, 6, 7, 8, 9, 10, 11 or 12 carbon atoms.

The term “perfluorotrialkylamine” as used herein refers to a tertiary amine bearing three perfluoroalkyl groups that may be the same or different.

The term “perfluoroalkylether” as used herein refers to an ether bearing two perfluoroalkyl groups that may be the same or different.

The term “perfluoroalkylpolyether” as used herein refers to a polyether comprising perfluoroalkyl groups on each end with a repeat unit made up of alternating perfluoroalkylene groups and oxygen atoms.

The term “perfluorocycloalkane” as used herein means a mono- or bicyclic, saturated cycloalkane in which each hydrogen atom has been replaced with a fluorine atom. In some embodiments of the present application the number of carbon atoms that are possible in the referenced perfluorocycloalkane are indicated by the numerical prefix “Cₙ₁₋ₙ₂”. For example, the term C₈₋₁₆perfluorocycloalkane means a perfluorocycloalkane having 8, 9, 10, 11, 12, 13, 14, 15 or 16 carbon atoms. In some embodiments, the perfluorocycloalkane group contains more than one cyclic structure or rings. When a perfluorocycloalkane group contains more than one cyclic structure or rings, the cyclic structures are fused, bridged, spiro connected or linked by a single bond. A first cyclic structure being “fused” with a second cyclic structure means the first cyclic structure and the second cyclic structure share at least two adjacent atoms therebetween. A first cyclic structure being “bridged” with a second cyclic structure means the first cyclic structure and the second cyclic structure share at least two non-adjacent atoms therebetween. A first cyclic structure being “spiro connected” with a second cyclic structure means the first cyclic structure and the second cyclic structure share one atom therebetween.

The term “alkyl” as used herein, whether it is used alone or as part of another group, means straight or branched chain, saturated alkyl group, that is a saturated carbon chain that contains substituents on one of its ends. The number of carbon atoms that are possible in the referenced alkyl group are indicated by the numerical prefix “Cₙ₁₋ₙ₂”. For example, the term C₁₋₄alkyl means an alkyl group having 1, 2, 3 or 4 carbon atoms.

The term “alkane” as used herein means straight or branched chain, saturated alkane, that is a saturated carbon chain.

The term “alkylene” as used herein, whether it is used alone or as part of another group, means straight or branched chain, saturated alkylene group, that is a saturated carbon chain that contains substituents on two of its ends. The number of carbon atoms that are possible in the referenced alkylene group are indicated by the numerical prefix “Cₙ₁₋ₙ₂”. For example, the term C₁₋₆alkylene means an alkylene group having 1, 2, 3, 4, 5 or 6 carbon atoms.

The term “halo” as used herein refers to a halogen atom and includes F, Cl, Br and I.

The term “suitable” as used herein means that the selection of the particular compound or conditions would depend on the specific synthetic manipulation to be performed, and the identity of the molecule(s) to be transformed, but the selection would be well within the skill of a person trained in the art. All process/method steps described herein are to be conducted under conditions for the reaction to proceed to a sufficient extent to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

The expression “proceed to a sufficient extent” as used herein with reference to the reactions or process/method steps disclosed herein means that the reactions or process/method steps proceed to an extent that conversion of the starting material or substrate to product is optimized for a given set of conditions. Conversion may be optimized when greater than about 5, 10, 15, 20, 25, 30, 35, 40, 45, 50, 55, 60, 65, 70, 75, 80, 85, 90, 95 or 100% of the starting material or substrate is converted to product.

### II. Processes

The advent of 3D printing has allowed for rapid bench-top fabrication of molds for casting polydimethylsiloxane (PDMS) chips, a widely-used polymer in prototyping microfluidic devices. While fabricating PDMS devices from 3D printed molds is fast and cost-effective, creating smooth surface topology may, for example be dependent on the printer's quality. In the studies described herein, smooth PDMS channels have now been produced from these molds by a technique in which a lubricant is tethered to the surface of a 3D printed mold, which results in a smooth interface for casting PDMS. Fabricating the omniphobic-lubricant-infused molds (OLIMs) was accomplished by coating the mold with a fluorinated-silane to produce a high affinity for the lubricant, which tethers it to the mold. PDMS devices cast onto OLIMs produced significantly smoother topology and can be further utilized to fabricate smooth-channeled PDMS devices. Using this method, the surface roughness of PDMS microfluidic channels was reduced from 2 to 0.2 μm (a 10-fold decrease), as well as demonstrated proper operation of the fabricated devices with advantageous optical properties compared to the rough devices. Furthermore, a COMSOL simulation was performed to investigate how the distinct surface topographies compare regarding their volumetric velocity profile and the shear rate produced. Simulation results showed that, near the channel's surface, variations in flow regime and shear stress is significantly reduced for the microfluidic channels cast on OLIM compared to the ones cast on uncoated 3D printed molds. The present fabrication method can produce high surface-quality microfluidic devices, comparable to the ones cast on photolithographically fabricated molds while avoiding its costly and time-consuming fabrication process. The use of a lubricant-infused mold e.g. an OLIM may also have advantages in that it can reduce adhesion forces between the mold and casted material, allowing for faster and effortless delamination processes. In addition, it may, for example, mitigate the use of post-processing to obtain a smooth surface finish on the cured material.

Accordingly, the present application includes process for fabricating a molded object, the process comprising:
coating a mold with a layer comprising a lubricant-tethering group to obtain a tether-coated mold;
depositing a lubricant on the tether-coated mold to obtain a lubricant-infused mold (LIM);
depositing a molded object precursor into the LIM and solidifying to obtain the molded object; and
removing the molded object from the LIM.

The term “lubricant-tethering group” as used herein refers to a functional group having a chemical composition such that it is attracted to the lubricant deposited on/tethered to the layer. The identities of the lubricant and the lubricant-tethering group are selected such that the lubricant is substantially immobilized onto the surface of the mold in a layer of sufficient thickness to produce a liquid interface between the mold and the molded object precursor/molded object. For example, in some embodiments, the lubricant is hydrophobic and the lubricant-tethering group is hydrophobic. In some embodiments, the lubricant is hydrophilic and the lubricant-tethering group is hydrophilic. In some embodiments, the lubricant comprises a perfluorocarbon oil and the lubricant-tethering group comprises a perfluorocarbon group.

In an embodiment, the layer comprising the lubricant-tethering group and the lubricant deposited thereon form a hydrophilic surface, a hydrophobic surface or an omniphobic surface. In another embodiment, the layer comprising the lubricant-tethering group and the lubricant deposited thereon form a hydrophilic surface. In a further embodiment, the layer comprising the lubricant-tethering group and the lubricant deposited thereon form a hydrophobic surface. In another embodiment of the present application, the layer comprising the lubricant-tethering group and the lubricant deposited thereon form an omniphobic surface and the lubricant-infused mold is an omniphobic lubricant-infused mold (OLIM).

The lubricant-tethering group is comprised in any suitable layer that can be applied to the surface of the mold using any suitable surface chemistry technique, the selection of which can be made by a person skilled in the art. In an embodiment, the layer comprising the lubricant-tethering group is a self-assembled monolayer (SAM). In an embodiment, the SAM comprises perfluorocarbon groups. In another embodiment, the SAM comprises C₃₋₁₂perfluoroalkyl groups. In another embodiment of the present application, the SAM comprises a siloxane network in which each perfluorocarbon group (e.g. the C₃₋₁₂perfluoroalkyl group) is linked to a silicon atom in the siloxane network, optionally by a linker comprising a C₁₋₆alkylene moiety. In a further embodiment, the SAM comprises a siloxane network of the following structure:

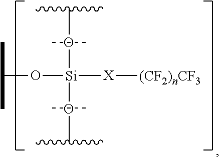

wherein
each X is independently a single bond or is C₁₋₆alkylene;
each n is independently an integer of from 0 to 12;
▬ represents the surface of the mold; and
each [symbol] represents an oxygen atom in the siloxane network.

It will be appreciated by a person skilled in the art that the dashed line in the indicates that the oxygen is shared between the silicon atom shown and another atom (e.g. another silicon atom) in the siloxane network. It will also be appreciated by a person skilled in the art that the number of network linkages in the siloxane network will depend, for example, on the surface area of the mold.

The mold is coated with the SAM by any suitable process, the selection of which can be readily made by the person skilled in the art based on the identities of the mold and the SAM. In an embodiment, the mold is coated with the SAM by a process comprising depositing a compound of the structure:

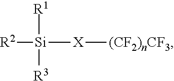

wherein
X is a single bond or is C₁₋₆alkylene;
n is an integer of from 0 to 12; and
R¹, R² and R³ are each independently a hydrolysable group.

The deposition comprises any suitable process, the selection of which can be made by a person skilled in the art. For example, the skilled person would readily understand that the deposition comprises conditions which would hydrolyse the hydrolysable group to form a siloxane network. In an embodiment, the deposition comprises chemical vapor deposition followed by curing at a temperature and for a time for the hydrolysis of the hydrolysable group to form the siloxane network to proceed to a sufficient extent. In an embodiment, the curing comprises curing at elevated temperature (e.g. a temperature of from about 40° C. to about 80° C. or about 60° C.) under air for a time of about 4 hours to about 24 hours or about 16 hours. In another embodiment, the chemical vapor deposition comprises incubating the mold with the compound for a time of at least about 1 hour (e.g. a time of from about 1 hour to about 4 hours or about 1 hour to about 2 hours) under suitable vacuum pressure (e.g. a vacuum pressure of from about −0.06 MPa to about −0.09 MPa or about −0.08 MPa). It will be appreciated by a person skilled in the art that depending on the material from which the mold is formed, activation of the surface by means, for example, of treatment with oxygen plasma is carried out prior to chemical vapor deposition. Accordingly, in some embodiments, the process further comprises treatment of the mold to activate the surface prior to chemical vapor deposition. In another embodiment of the present application, the treatment comprises applying oxygen plasma for a time for the activation of the surface to proceed to a sufficient extent (e.g. a time of about 30 seconds to about 10 minutes or about 3 minutes).

The hydrolysable group is any suitable hydrolysable group, the selection of which can be made by a person skilled in the art. In an embodiment, R¹, R² and R³ are independently halo or —O—C₁₋₄alkyl. In another embodiment, R¹, R² and R³ are all independently halo. In a further embodiment, R¹, R² and R³ are all independently —O—C₁₋₄alkyl. In another embodiment, R¹, R² and R³ are all Cl.

In an embodiment, X is C₁₋₆alkylene. In another embodiment, X is C₁₋₄alkylene. In a further embodiment, X is —CH₂CH₂—.

In an embodiment, n is an integer of from 3 to 12. In another embodiment, n is an integer of from 3 to 8. In another embodiment, n is an integer of from 4 to 6. In a further embodiment, n is 5.

In an embodiment, R¹, R² and R³ are all Cl, X is —CH₂CH₂— and n is 5. In another embodiment of the present application, the deposition comprises chemical vapor deposition followed by curing at elevated temperature under air, R¹, R² and R³ are all Cl, X is —CH₂CH₂— and n is 5.

In an embodiment, the lubricant is a perfluorocarbon oil. In another embodiment, the perfluorocarbon oil is a perfluorotrialkylamine (e.g. a C₃₋₇perfluorotrialkylam ine such as perfluorotripentylamine also known as Fluorinert™ FC-70), a perfluoroalkylether or perfluoroalkylpolyether (e.g. a polymer of polyhexafluoropropylene oxide of the formula F—(CF(CF₃)—CF₂—O)ₘ—CF₂CF₃, wherein m is an integer of from 10 to 60 such as Krytox™ 100, Krytox™ 103, Krytox™ 104, Krytox™ 105, Krytox™ 106 or Krytox™ 1506), a perfluoroalkane (e.g. a C₅₋₁₂perfluoroalkane such as perfluorohexane or perfluorooctane) or a perfluorohaloalkane, wherein halo is other than fluoro (e.g. a C₅₋₁₂perfluorobromoalkane such as bromoperfluorooctane). In another embodiment, the hydrophobic lubricant is a perfluorocycloalkane. In another embodiment, the hydrophobic lubricant is a C₈-C₁₆perfluorocycloalkane. In a further embodiment, the hydrophobic lubricant is perfluorodecalin or perfluoroperhydrophenanthrene. In another embodiment of the present application, the hydrophobic lubricant is perfluorodecalin. In a further embodiment, the hydrophobic lubricant is perfluoroperhydrophenanthrene.

The mold is formed of any suitable material, the selection of which can be made by a person skilled in the art. In an embodiment, the mold comprises, consists essentially of or consists of a polymer (e.g. polyvinyl chloride (PVC), polycarbonate (PC), polytetrafluoroethylene (PTFE), poly(methyl methacrylate) (PMMA), polystyrene or a silicone elastomer such as a silicone elastomer comprising a polydimethylsiloxane (PDMS)), ceramic, metal (e.g. gold, aluminum, copper, stainless steel, titanium, zinc, copper, aluminium, magnesium, lead, pewter or tin-based alloys), sapphire, glass, carbon in different forms (e.g. graphene or carbon fiber) or silicon. In some embodiments of the application, the mold is formed of a material that is suitable for 3D printing (e.g. a 3D printable plastic, polymer, resin or metal). The selection of a material suitable for 3D printing can be readily made by a person skilled in the art. In an embodiment, the mold comprises, consists essentially of or consists of a silicone elastomer.

The molded object precursor will depend, for example, on the desired composition of the molded object and/or the means of deposition thereof into the mold and can be readily selected by a person skilled in the art. It will be appreciated by the person skilled in the art that the molded object precursor is in a form (e.g. flexible, semi-solid or liquid-phase) such that it can take the form of the mold then subsequently it is solidified by the mechanism appropriate to the identity of the particular molded object precursor being used (e.g. curing or setting) to obtain the molded object. In an embodiment, the molded object precursor is a liquid-phase molded object precursor. In an embodiment, the liquid phase molded object precursor comprises a cement, polymer (e.g. polyvinyl chloride (PVC), polycarbonate (PC), polytetrafluoroethylene (PTFE), poly(methyl methacrylate) (PMMA), polystyrene or silicone elastomer precursors such as to a silicone elastomer comprising a polydimethylsiloxane (PDMS)), plastic, ceramic, metal (e.g. gold, aluminum, copper, stainless steel, titanium, zinc, copper, aluminium, magnesium, lead, pewter or tin-based alloys), glass or silicon in liquid-phase (e.g. in a molten phase or in solution, as suitable for the particular molded object precursor).

In an embodiment, the molded object comprises, consists essentially of or consists of a silicone elastomer. Molded object precursors such as liquid-phase molded object precursors for preparing molded objects comprising, consisting essentially of or consisting of silicone elastomers can be readily selected by a person skilled in the art. In an embodiment, the liquid-phase molded object precursor is prepared by mixing a first composition comprising a liquid polydialkylsiloxane and a second composition comprising a curing agent. In another embodiment, the solidifying comprises curing at elevated temperature (e.g. at a temperature of from about 40° C. to about 80° C. or about 60° C. for a time of from about 4 hours to about 8 hours or about 6 hours) under air. In another embodiment, the liquid polydialkylsiloxane is a polydimethylsiloxane. In a further embodiment, the liquid polydialkylsiloxane is a dimethylvinylsiloxy-terminated polydimethylsiloxane. In another embodiment, the liquid-phase object precursor is Sylgard™ 184.

In an embodiment, the mold has been fabricated by a process comprising 3D printing. In another embodiment, the 3D printing comprises fuel deposition modeling, selective laser sintering (SLS) or multi-jet modeling (MJM). In a further embodiment, the 3D printing comprises multi-jet modeling (MJM).

In the studies described herein below, the devices fabricated from a 3D printed mold (without lubricant), a positive 3D printed OLIM or a rough PDMS mold produced from a negative 3D printed mold presented an average roughness of about 2 μm within the channels of the mold. In contrast, a negative 3D printed OLIM generated a smooth-channeled positive PDMS mold, and the PDMS device cast on the positive PDMS mold showed an average roughness of about 200 nm, a 10-fold decrease compared to the devices cast on non-coated surfaces Accordingly, in an embodiment, the mold is a negative mold and the molded object is a positive mold. In another embodiment, the process is for preparing a second object from the positive mold and the process further comprises:
optionally coating the positive mold with a layer comprising a demolding-promoting group to obtain a coated positive mold;
depositing a second molded object precursor into the optionally coated positive mold and solidifying to obtain the second molded object; and
removing the second molded object from the optionally coated positive mold.

Accordingly, the present application also includes a process for preparing a molded object, the process comprising:
coating a negative mold with a layer comprising a lubricant-tethering group to obtain a tether-coated negative mold;
depositing a lubricant on the tether-coated negative mold to obtain a lubricant-infused negative mold (LInM);
depositing a molded object precursor into the LInM and solidifying to obtain a positive mold;
removing the positive mold from the LInM;
optionally coating the positive mold with a demolding-promoting group to obtain a coated positive mold;
depositing a second molded object precursor into the optionally coated positive mold and solidifying to obtain the molded object; and
removing the molded object from the optionally coated positive mold.

The present application also includes a process for fabricating a positive mold from a negative mold, the process comprising:
coating a negative mold with a layer comprising a lubricant-tethering group to obtain a tether-coated negative mold;
depositing a lubricant on the tether-coated negative mold to obtain a lubricant-infused negative mold (LInM);
depositing a molded object precursor into the LInM and solidifying to obtain the positive mold; and
removing the positive mold from the LInM.

It will be appreciated by a person skilled in the art that the positive mold is coated with the demolding-promoting group to obtain the coated positive mold in embodiments wherein the properties of the molded object precursor and/or the molded object and the mold are such that delamination (demolding/removal) would be impeded or prevented. For example, in embodiments wherein the material properties of the molded object and the mold are dissimilar, the layer comprising the demolding-promoting group may not be required. Alternatively, in embodiments such as wherein liquid PDMS is cast into a mold comprising PDMS, such components may, for example, bond without the presence of the layer comprising the demolding-promoting group such that delaminating (demolding/removal) the molded object may fail. The term “demolding-promoting group” as used herein refers to a group, when comprised in a layer, that impedes or prevents bonding between the mold and the molded object precursor and/or the molded object such that delaminating (demolding/removal) of the molded object from the mold is facilitated or improved in comparison to the delaminating (demolding/removal) of the molded object from the mold without the presence of a layer comprising the demolding-promoting group. The demolding-promoting group is any suitable demolding-promoting group, the selection of which can be made by a person skilled in the art. In an embodiment, the layer comprising the demolding-promoting group is a second self-assembled monolayer (SAM). It will be appreciated by the person skilled in the art that embodiments relating to the second SAM and the deposition thereof can be varied as described herein above for the SAM. The SAM and the second SAM can be the same or different.

The second molded object precursor will depend, for example, on the desired composition of the second molded object and/or the means of deposition thereof into the mold and can be readily selected by a person skilled in the art. It will be appreciated by the person skilled in the art that the second molded object precursor is in a form (e.g. flexible, semi-solid or liquid-phase) such that it can take the form of the mold then subsequently it is solidified by the mechanism appropriate to the identity of the particular second molded object precursor being used (e.g. curing or setting) to obtain the molded object. In an embodiment, the second molded object precursor is a second liquid-phase molded object precursor. In an embodiment, the second liquid phase molded object precursor comprises a cement, polymer (e.g. polyvinyl chloride (PVC), polycarbonate (PC), polytetrafluoroethylene (PTFE), poly(methyl methacrylate) (PMMA), polystyrene or silicone elastomer precursors such as to a silicone elastomer comprising a polydimethylsiloxane (PDMS)), plastic, ceramic, metal (e.g. gold, aluminum, copper, stainless steel, titanium, zinc, copper, aluminium, magnesium, lead, pewter or tin-based alloys), glass or silicon in liquid-phase (e.g. in a molten phase or in solution, as suitable for the particular second molded object precursor). In an embodiment, the second molded object comprises, consists essentially of or consists of a silicone elastomer. Molded object precursors such as liquid-phase molded object precursors for preparing molded objects comprising, consisting essentially of or consisting of silicone elastomers can be readily selected by a person skilled in the art. In an embodiment, the second liquid-phase molded object precursor is prepared by mixing a first composition comprising a liquid polydialkylsiloxane and a second composition comprising a curing agent. In another embodiment, the solidifying comprises curing at elevated temperature (e.g. at a temperature of from about 40° C. to about 80° C. or about 60° C. for a time of from about 4 hours to about 8 hours or about 6 hours) under air. In another embodiment, the liquid polydialkylsiloxane is a polydimethylsiloxane. In a further embodiment, the liquid polydialkylsiloxane is a dimethylvinylsiloxy-terminated polydimethylsiloxane. In another embodiment, the liquid-phase object precursor is Sylgard™ 184.

In an embodiment, the negative mold comprises a low-resolution microstructure and the positive mold fabricated therefrom comprises a corresponding smooth-surfaced microstructure. In another embodiment of the present application, the average surface roughness of the low-resolution microstructure is from about 1 μm to about 3 μm or about 2 μm and the average surface roughness of the smooth-surfaced microstructure is from about 0.1 μm to about 0.3 μm or about 0.2 μm. In a further embodiment, the average surface roughness of the smooth-resolution microstructure is a factor of about 10 lower than the average surface roughness of the low-resolution microstructure.

The microstructure is any suitable microstructure, the design of which can be readily made by a person skilled in the art. In an embodiment, the microstructure is selected from a microchannel, a micropillar, a microbead, a microparticle, a microcantilever, a microgear and combinations thereof. In an embodiment, the microstructure is a microchannel. In another embodiment, the mold comprises a nanostructure such as for fabricating a nanoparticle.

In an embodiment, the second molded object is for use as a component of a microfluidics device. Accordingly, the present application also includes a process for preparing a microfluidics device comprising bonding a molded object that is for use as a component of a microfluidics device (prepared by a process for preparing a molded object of the present application) to a substrate. The substrate is any suitable substrate, the selection of which can be made by a person skilled in the art. In an embodiment, the substrate comprises, consists essentially of or consists of a polydialkylsiloxane elastomer. In another embodiment, the polydialkylsiloxane elastomer is a polydimethylsiloxane elastomer. The means for bonding the molded object that is for use as a component of the microfluidics device to the substrate comprises any suitable means, the selection of which can be made by a person skilled in the art. In an embodiment, the means for bonding comprises applying oxygen plasma for a time for the bonding of the molded object that is for use as a component of the microfluidics device to the substrate to proceed to a sufficient extent (e.g. a time of about 30 seconds to about 5 minutes or about 1 minute). In another embodiment of the present application, the process for preparing the microfluidics device further comprises cutting a desired number of inlets and/or outlets in the microfluidics device for connecting the microchannel to tubing.

The molded object precursor (e.g. the liquid-phase molded object precursor) is deposited into the mold by any suitable means, the selection of which can be readily made by a person skilled in the art. For example, the person skilled in the art would readily appreciate that the means for deposition will depend, for example, on the type of mold and/or the identity of the molded object precursor. In an embodiment, the deposition comprises a microfabrication technique (such as soft lithography e.g. using a 3D printed mold or soft lithography e.g. using a silicone mold fabricated by photolithography), injection molding, liquid-phase casting or hot embossing. For example, in some embodiments, the mold has a single surface and the liquid-phase molded object precursor is deposited by a process comprising casting the liquid-phase molded object precursor into the mold. In other embodiments, the mold comprises two or more surfaces and the liquid-phase molded object precursor is deposited by a process comprising injection molding the liquid-phase molded object precursor into the mold.

### III. Omniphobic Lubricant-Infused Molds (OLIMs)

Lubricant-infused coatings were used with inexpensive 3D printed molds to produce polymeric microfluidic devices. The resulting chips presented surface qualities similar to photolithography without varying the hydromechanics of the system. Surface roughness on microfluidic devices may be useful, for example, for studies where shear rate is investigated. Optical properties of the smooth fabricated surfaces were superior to those recovered from the rough mold. The use of a lubricant-coated mold e.g. an OLIM may also have advantages in that it can reduce adhesion forces between the mold and casted material, allowing for faster and effortless delamination processes. In addition, it may, for example, mitigate the use of post-processing to obtain a smooth surface finish on the cured material.

Accordingly, the present application also includes a lubricant-infused mold (LIM), the LIM comprising:
a mold;
a layer comprising a lubricant-tethering group coated on the mold; and
a lubricant tethered to the layer comprising the lubricant-tethering group.

In an embodiment, the mold comprises, consists essentially of or consists of a polymer (e.g. polyvinyl chloride (PVC), polycarbonate (PC), polytetrafluoroethylene (PTFE), poly(methyl methacrylate) (PMMA), polystyrene or a silicone elastomer such as a silicone elastomer comprising a polydimethylsiloxane (PDMS)), ceramic, metal (e.g. gold, aluminum, copper, stainless steel, titanium, zinc, copper, aluminium, magnesium, lead, pewter or tin-based alloys), sapphire, glass, carbon in different forms (e.g. graphene or carbon fiber) or silicon. In an embodiment, the mold comprises, consists essentially of or consists of a silicone elastomer. In another embodiment, the silicone elastomer comprises a polydialkylsiloxane. In a further embodiment, the polydialkylsiloxane is a polydimethylsiloxane. In an embodiment, the mold has been fabricated with pores or roughness. In some embodiments of the application, the mold is formed of a material that is suitable for 3D printing (e.g. a 3D printable plastic, polymer, resin or metal). The selection of a material suitable for 3D printing can be readily made by a person skilled in the art. Accordingly, in another embodiment, the mold has been fabricated by a process comprising 3D printing. In a further embodiment, the 3D printing comprises fuel deposition modeling, selective laser sintering (SLS) or multi-jet modeling (MJM). In another embodiment, the 3D printing comprises multi-jet modeling (MJM). In a further embodiment, the mold is a negative mold.

In an embodiment, the mold comprises a low-resolution microstructure. In another embodiment, the microstructure is selected from a microchannel, a micropillar, a microbead, a microparticle, a microcantilever, a microgear and combinations thereof. In another embodiment, the microstructure is a microchannel. In a further embodiment, the LIM is for fabricating a molded object that is for use as a component of a microfluidics device.

The lubricant-tethering group is comprised in any suitable layer that can be applied to the surface of the mold using any suitable surface chemistry technique, the selection of which can be made by a person skilled in the art. In an embodiment, the layer comprising the lubricant-tethering group is a self-assembled perfluorocarbon groups. In another embodiment, the SAM comprises C₃₋₁₂perfluoroalkyl groups. In another embodiment of the present application, the SAM comprises a siloxane network in which each perfluorocarbon group (e.g. the C₃₋₁₂perfluoroalkyl group) is linked to a silicon atom in the siloxane network, optionally by a linker comprising a C₁₋₆alkylene moiety. In a further embodiment, the SAM comprises a siloxane network of the following structure:

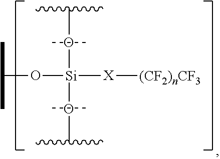

wherein
each X is independently a single bond or is C₁₋₆alkylene;
each n is independently an integer of from 0 to 12;
▬ represents the surface of the mold; and
each [symbol] represents an oxygen atom in the siloxane network.

In an embodiment, X is C₁₋₆alkylene. In another embodiment, X is C₁₋₄alkylene. In a further embodiment, X is —CH₂CH₂—.

In an embodiment, n is an integer of from 3 to 12. In another embodiment, n is an integer of from 3 to 8. In another embodiment, n is an integer of from 4 to 6. In a further embodiment, n is 5.

In an embodiment, X is —CH₂CH₂— and n is 5.

The identities of the lubricant and the lubricant-tethering group are selected such that the lubricant is substantially immobilized onto the surface of the mold in a layer of sufficient thickness to produce a liquid interface between the mold and a molded object precursor deposited therein and molded object fabricated from the molded object precursor. For example, in some embodiments, the lubricant is hydrophobic and the lubricant-tethering group is hydrophobic. In some embodiments, the lubricant is hydrophilic and the lubricant-tethering group is hydrophilic. In some embodiments, the lubricant comprises a perfluorocarbon oil and the lubricant-tethering group comprises a perfluorocarbon group.

In an embodiment, the layer comprising the lubricant-tethering group and the lubricant tethered thereto form a hydrophilic surface, a hydrophobic surface or an omniphobic surface. In another embodiment, the layer comprising the lubricant-tethering group and the lubricant tethered thereto form a hydrophilic surface. In a further embodiment, the layer comprising the lubricant-tethering group and the lubricant tethered thereto form a hydrophobic surface. In another embodiment of the present application, the layer comprising the lubricant-tethering group and the lubricant tethered thereto form an omniphobic surface and the lubricant-infused mold is an omniphobic lubricant-infused mold (OLIM).

In an embodiment, the lubricant is a perfluorocarbon oil. In another embodiment, the perfluorocarbon oil is a perfluorotrialkylamine (e.g. a C₃₋₇perfluorotrialkylamine such as perfluorotripentylamine also known as Fluorinert™ FC-70), a perfluoroalkylether or perfluoroalkylpolyether (e.g. a polymer of polyhexafluoropropylene oxide of the formula F—(CF(CF₃)—CF₂—O)ₘ—CF₂CF₃, wherein m is an integer of from 10 to 60 such as Krytox™ 100, Krytox™ 103, Krytox™ 104, Krytox™ 105, Krytox™ 106 or Krytox™ 1506), a perfluoroalkane (e.g. a C₅₋₁₂perfluoroalkane such as perfluorohexane or perfluorooctane) or a perfluorohaloalkane, wherein halo is other than fluoro (e.g. a C₅₋₁₂perfluorobromoalkane such as bromoperfluorooctane). In another embodiment, the hydrophobic lubricant is a perfluorocycloalkane. In another embodiment, the hydrophobic lubricant is a C₈-C₁₆perfluorocycloalkane. In a further embodiment, the hydrophobic lubricant is perfluorodecalin or perfluoroperhydrophenanthrene. In another embodiment of the present application, the hydrophobic lubricant is perfluorodecalin. In a further embodiment, the hydrophobic lubricant is perfluoroperhydrophenanthrene.

The following non-limiting examples are illustrative of the present application:

### EXAMPLES

### Example 1: Fabricating Smooth PDMS Microfluidic Channels from Low-Resolution 3D Printed Molds Using an Omniphobic Lubricant-Infused Coating

### I. Experimental and Computational Methodology

(a) Designing 3D printed molds: The three-dimensional (3D) mold was designed using Solidworks (Hawk Ridge Systems), with channel architecture composed of cross-sectional areas measuring 200×200 μm, and microchip layout encompassing commonly found cross-channel as well as Y-channel intraconnections. Two different mold types were tested. The first mold had protruding or positive structures in order to create hollow PDMS channels upon casting and curing. The second design had depressed/negative channels and was used to create a new PDMS mold with protruding structures for further casting steps. The 3D mold design was exported as a stereolithography (.STL) file and printed on a ProJet HD3000 (3D Systems, Rock Hill, USA).

(b) Omniphobic lubricant infused coating: In order to coat the mold, it was first sonicated in 70% ethanol for 10 minutes and allowed to air-dry. It was then oxygen plasma treated (Harrick Plasma) with a 100% oxygen source (Air liquid), for 3 minutes, and immediately placed in a vacuum chamber alongside a petri dish containing 400 μL of trichloro(1H,1H,2H,2H-perfluorooctyl)silane (Sigma-Aldrich Chemicals) to produce a self-assembled monolayer (SAM) of the silane. The mold was incubated for a minimum of 1 hour under a −0.08 MPa vacuum pressure for the chemical vapor deposition (CVD) of the fluorosilane to occur. Subsequently, the mold was cured overnight at 60° C. and then sonicated with ethanol to remove any fluorosilane not covalently bonded to the surface. Finally, perfluoroperhydrophenanthrene (PFPP) was added to the mold prior to use to form a smooth lubricant-infused interface. However, another compatible fluorocarbon lubricant such as perfluorodecalin (PFD) (Sigma-Aldrich) could also be used with a SAM comprising (1H,1H,2H,2H-perfluorooctyl)silyl groups or a similar group.

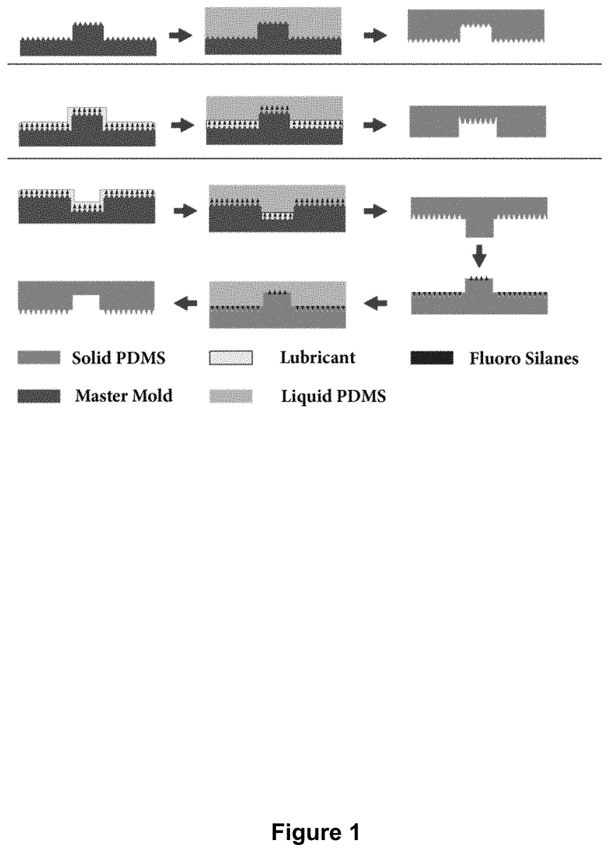

(c) Fabrication of PDMS devices: FIG. 1 displays an overview of manufacturing steps for the fabrication of different PDMS microfluidic chips. First, the 3D printed mold was further rendered hydrophobic through the fluoro-functionalization process described in Example 1, section 1(b). Liquid PDMS and curing agent (Sylgard™ 184 from Dow Corning, MI, USA) were then mixed with a 10:1 ratio (w/w) and desiccated in a vacuum chamber for 1 hour prior to casting onto the surface-modified mold. The control devices were created by casting PDMS directly into the positive mold (without any surface modification; FIG. 1, top flowchart). All devices were cured in an oven at 60° C. for a minimum of six hours. The middle flowchart in FIG. 1 illustrates the outcome of casting PDMS on a positive OLIM. This method results in an increased smoothness on the adjacent areas to the channel while producing a rough inner channel topology. Finally, in the bottom flowchart in FIG. 1, a smooth PDMS (positive) mold was created by casting PDMS onto a negative OLIM treated device. The PDMS was cured for six hours at 60° C. and subsequently, fluoro functionalized with the CVD process described in Example 1, section 1(b). Finally, a new batch of liquid PDMS was cast onto it (without lubricant) and cured, creating the PDMS device with smooth inner channels. The final microfluidic device was obtained by bonding the produced PDMS channels to a flat PDMS layer using oxygen plasma for 1 minute.

(d) Brightfield and Scanning Electron Microscopy: The PDMS devices were characterized, optically, through the acquisition and comparison of brightfield microscopy images. A z-stack of images were obtained using a Zeiss inverted fluorescent microscope (Zeiss Observer axio Z1, and Zen2 Blue edition software) with an automatic bed. Scanning electron microscopic (SEM) images were obtained at McMaster University's Canadian Center for Electron Microscopy (CCEM), using a JSM-7000F scanning electron microscope.

(e) OLIM characterization: In order to characterize the surface energies, the contact and sliding angles of the mold's surface were measured. Contact angles were obtained by adding a 2 μL droplet of Milli-Q water onto the surfaces, dispensed by an Optical Contact Angle (OCA 35) machine. Sliding angles were measured by first wicking the surfaces with PFD lubricant. After decanting any excess, the surfaces were placed on a digital scale, which measures the angle of inclination, and a 5 μL droplet of Milli-Q water was pipetted onto the lubricated device. Sliding angle was defined as the angle of inclination at which the droplet started moving. Surface roughness was characterized using the vertical scanning interferometric (VSI) technique of the Wyko NT1100 Optical Profiling System (Veeco, Tuscon Ariz., USA) and analyzed using software Vision32 version 2.303. A minimum of five observations on three different devices per fabrication process were tested for the parameters listed above.

(f) COMSOL Simulations: COMSOL software (COMSOL Multiphysics 5.3) was used to perform the channel shear stress and velocity profile simulations. Two microfluidic channels with dimensions of 1000 μm length×100 μm width×20 μm height were designed. The bottom surfaces of the channels were created using the parametric surface module of COMSOL to have an arithmetical mean height (Sₐ) of 2 μm and 0.2 μm, for each independent channel. The leading equation for roughness production was achieved using spatial frequencies Equation²¹:

$$f ( x , y ) = {\sum }_{m = - M}^{M} {\sum }_{n = - N}^{N} \frac{1}{( {m}^{2} + {n}^{2} )} \text{?} g ( m , n ) cos ( 2 π ( m x + n y ) + ϕ ( m , n ) ) \\ \text{?} \text{indicates text missing or illegible when filed} \qquad ( 1 )$$

where x and y are spatial coordinates, M and N are the spatial frequency resolutions which were set equal to 40 in this study, β is the spectral exponent which was set equal to 0.4, g(m,n) is a zero-mean Gaussian Random function, and φ(m,n) are phase angles determined by a Zero-mean Uniform Random function in the interval between −Π/2 and Π/2 in COMSOL. The function of f(x,y) was scaled in the z-direction to achieve the desired roughness numbers.

The amplitude parameter of the arithmetical mean height (Sₐ) was chosen to indicate the surface roughness according to the following equation:

$${S}_{a} = \frac{1}{A} {\int \int }_{A} \vert f ( x , y ) \vert d x d y \qquad ( 2 )$$

where A is the mean-plane area. Laminar flow physics of COMSOL was applied in the simulations, using the Navier-Stokes equations with continuity, assuming no-slip boundary conditions, and the simulations were studied in stationary mode. An incompressible Newtonian fluid with the properties of water was perfused inside the channels to simulate the effect of roughness on shear rate and velocity of the fluid.

(g) Cell media perfusion: Microfluidic devices were created with the fabrication procedures described hereinabove in Example 1, section 1(c). A singular inlet-outlet system was created and Human Umbilical Vein Endothelial Cells (HUVEC) were injected into both rough and smooth devices at the constant velocity of 1 μL min⁻¹. The footage was recorded with a Zeiss inverted microscope with a 10× objective and a digital camera.

(h) Statistics: All statistical analyses were performed with open-source software R version 3.3.2 (www.r-project.org). Parametric data were tested with a one-way ANOVA, with additional posthoc Tukey Honest Significant Difference test from the R package stats version 3.3.2. Non-parametric data was tested with Kruskal-Wallis Rank Sum Test from the R package stats version 3.3.2 followed by a multiple comparison test from R package pgirmess version 1.6.5. Significance levels were defined as significant (*) p-value <0.05, highly significant (**) at p-value <0.01 and very significant (***) at p-value <0.001.

### II. Results and Discussion

Table 1 highlights the differences in printing resolutions between 3D printer technologies from several manufacturers. Given the various resolutions obtainable through 3D printing, the production of microfluidic molds using MJM printing technology was investigated. MJM printers are equipped with high-resolution nozzles, are able to produce ready-to-use, fully cured devices, and use supporting material that is easily removed, making them a useful choice for producing microfluidic devices and molds.²²

### (a) Qualitative Measurement of Channel Smoothness Using Brightfield Imaging

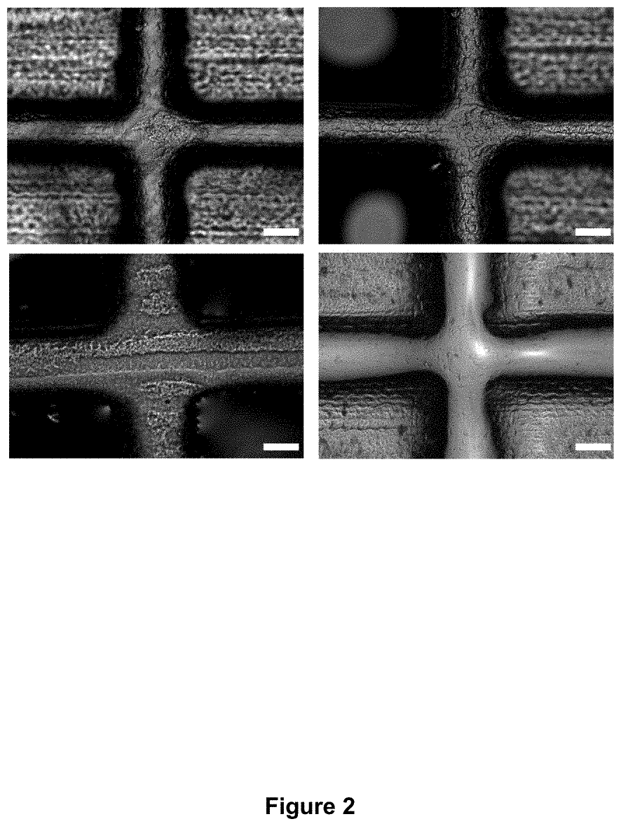

In order to investigate the surface smoothness, all devices were fabricated and then imaged using brightfield microscopy and scanning electron microscopy (SEM). Four unique fabrication processes were used on the 3D printed molds to cast the PDMS: an unmodified 3D printed positive mold, a lubricated 3D printed positive mold, a 3D printed positive OLIM and a negative 3D printed OLIM. The negative OLIM produced a smooth PDMS mold with protruding channels which were silanized and used to cast devices with smooth PDMS channels. The resulting cross-channel interconnect of each microfluidic PDMS device were imaged as shown in FIG. 2.

The PDMS device created from the original mold had rough inner channels and outer surfaces, as seen in the upper left hand image of FIG. 2. In primary efforts to improve the smoothness of the device, lubricating the mold (without chemical modification) was explored; however, curing PDMS on an unsilanized mold containing only the lubricant resulted in rough inner channels. Additionally, shown in the upper right hand image of FIG. 2, the lubricant was displaced and aggregated by the liquid PDMS, creating depressions in the resulting PDMS device. It was then hypothesized that the modification of the mold's surface using fluorosilane groups, would help lock the lubricant to the mold, preventing it from being displaced. Based on this hypothesis, a positive OLIM was fabricated. The resulting PDMS device had the inverse desired topology: rough inner channels and smooth outer surfaces seen (lower left hand image of FIG. 2). Final device fabrication was obtained using a negative OLIM to create a secondary positive PDMS mold with smooth protruding features, which was subsequently used to fabricate the PDMS substrate with smooth inner-channel topography, seen in lower right hand image of FIG. 2.

### (b) OLIM Surface Characterization

As shown in Example 1, section 2(a), untreated surfaces produced rough surface topology on the PDMS chips. Additionally, lubricating the surfaces without coating the molds caused deformations in the fabricated PDMS devices. However, the fluorosilane-treated and lubricated negative mold proved useful for the fabrication of smooth microfluidic channeled devices, through the formation of a PDMS mold. To further characterize the coating and investigate omniphobic properties, the contact and sliding angles of the molds were measured to correlate to the likeness in surface energies between the lubricant and fluorosilane groups.

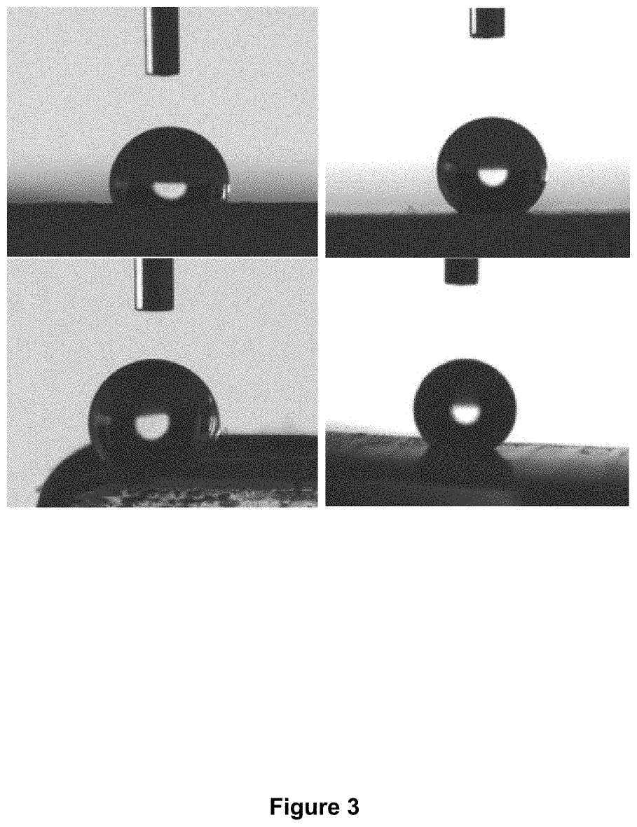

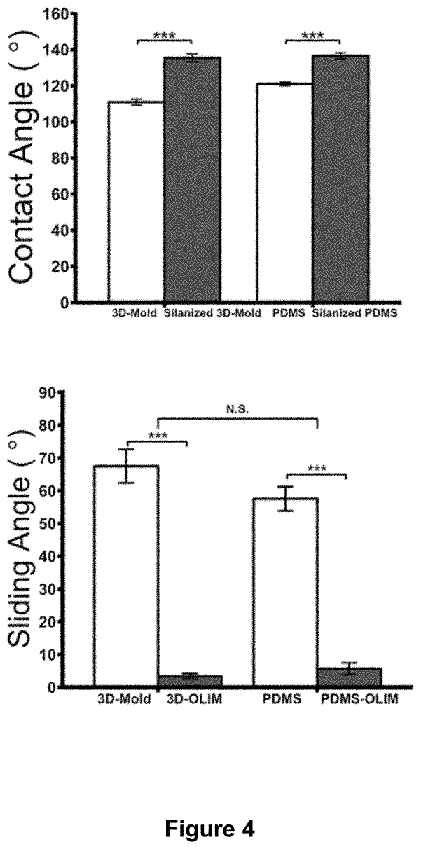

FIG. 3 and FIG. 4 display the results of the contact and sliding angle measurements obtained from the different fabricated mold surfaces. It can be seen that the contact angle of the 3D-mold increases after the fluorosilanization treatment (FIG. 3, upper right image) compared to its unsilanized counterpart (FIG. 3, upper left image). Furthermore, the same trend can be seen between the smooth untreated and silanized PDMS molds fabricated from an OLIM, as shown in the lower left and right images of FIG. 3, respectively. Silanized molds have significantly larger contact angles compared to the untreated molds (FIG. 4, upper plot). The larger contact angles represent an increase in the difference of surface energies between the two molds. While not wishing to be limited by theory, the shift in surface energy may provide a favorable affinity for the fluorine-rich lubricant over water, or PDMS. The sliding angles (FIG. 4, lower plot) also highlight the difference in surface energy between treated and untreated devices: low sliding angles (under 10 degrees) reveal a greater difference in surface energy between the treated and untreated molds. Accordingly, these results show that silanized molds can be utilized to effectively cast PDMS that cures on top of the smooth interface obtained from a lubricated mold. This procedure reduces the amount of surface variance caused by casting into a 3D printed mold and produces a smooth device.

### (c) Roughness Analysis on OLIM

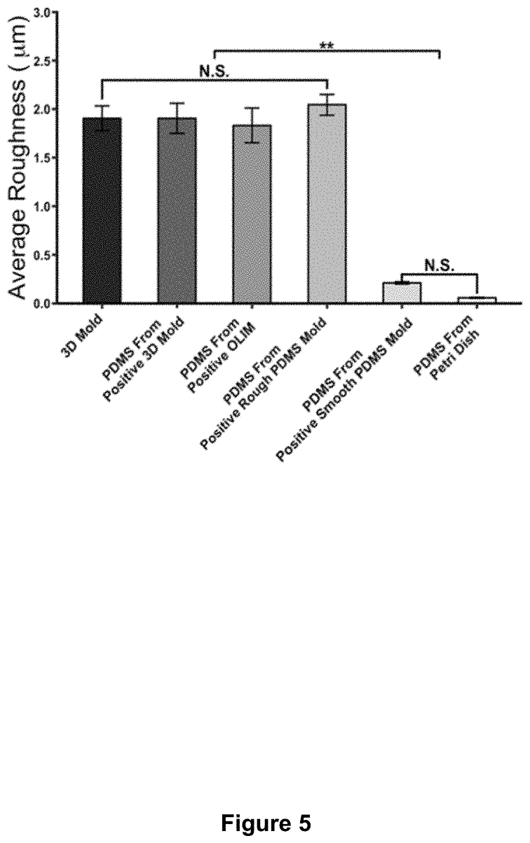

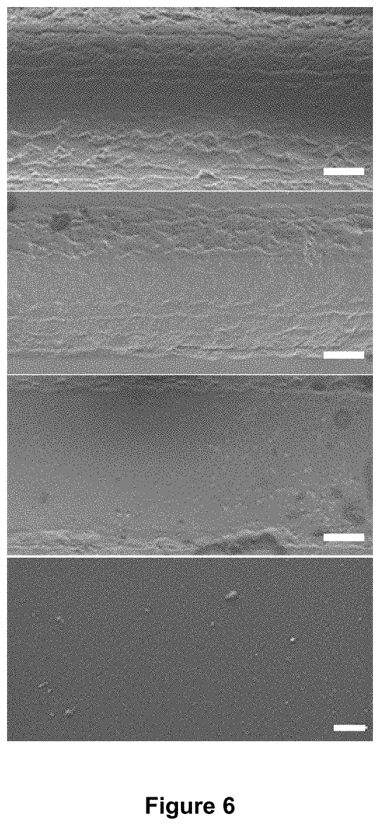

Once the smoothness of the inner channels was visually confirmed, quantitative measurements were taken using the vertical scanning interferometric (VSI) method of an optical profilometer. The average roughness (Rₐ) was obtained from within the channel portions of the device both for the molds, as well as the final PDMS microfluidic chip (FIG. 5). FIG. 6 shows exemplary scanning electron microscopy (SEM) images displaying the surface roughness of the fabricated PDMS microchannels. Interestingly, there were no significant differences between the average roughness within the channels of the mold and the channels of several other PDMS devices. Mainly, the devices fabricated from the 3D printed mold, the positive 3D printed OLIM or the rough PDMS mold produced from a negative 3D printed mold, which presented an average roughness of about 2 μm. Conversely, the PDMS device cast on the smooth positive PDMS mold showed an average roughness of about 200 nm, a 10-fold decrease compared to the devices cast on non-coated surfaces (FIG. 5). This value was not statistically different to the roughness of a PDMS surface cast directly in a cell culture petri dish which is considered an ideal surface for cell culture and optical imaging.

### (d) Simulation Studies

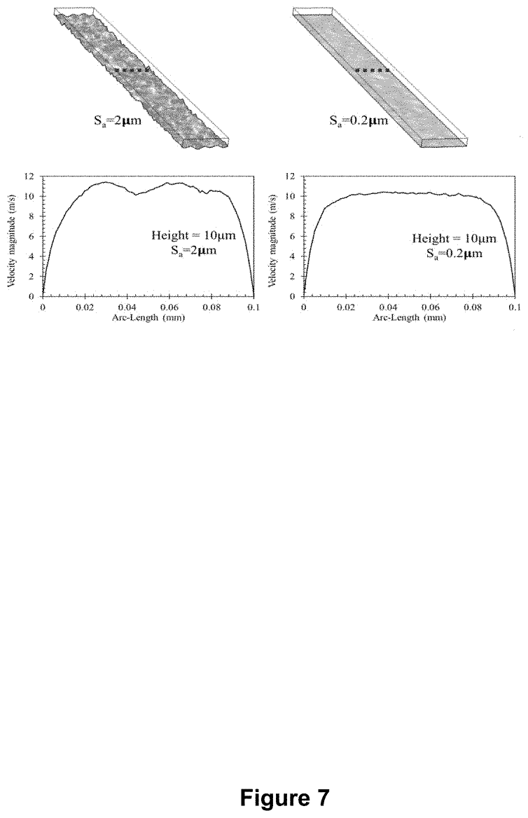

COMSOL finite element method (FEM) simulation was used to investigate the importance of surface roughness on physical properties of a fluid flowing throughout a microfluidic device. In the simulations, water was perfused as a fluid with a flow rate of 800 μl min⁻¹ inside two rectangular cross-section microchannels (1000 μm length×100 μm width×20 μm height) each of which had a different rough surface at the bottom face similar to the fabricated devices (FIG. 7, upper). The 3D arithmetical mean height (Sₐ) roughness parameter of the smoother surface was set to 0.2 μm and 2 μm for the rougher surface.

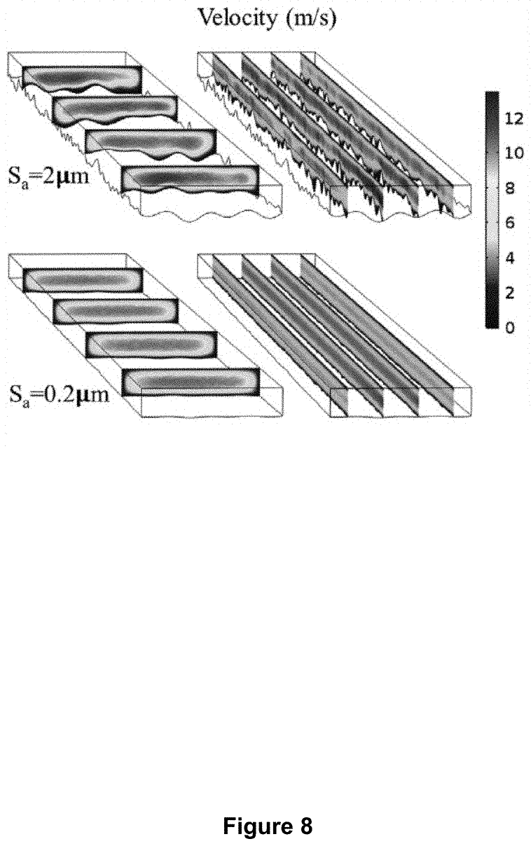

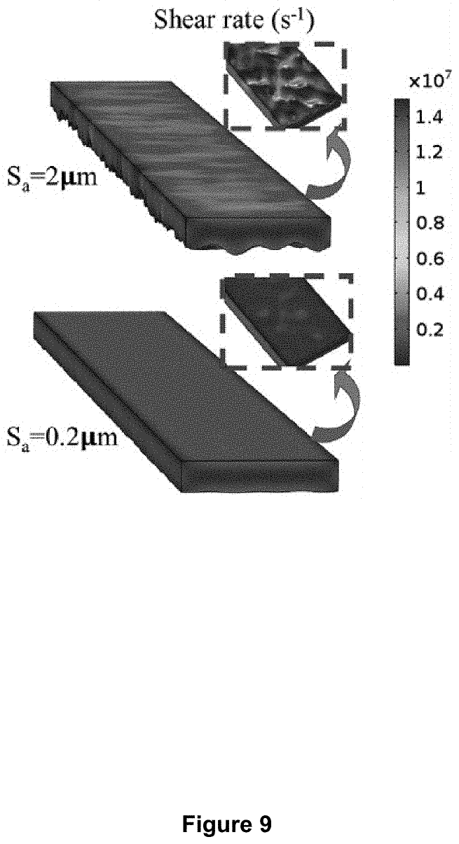

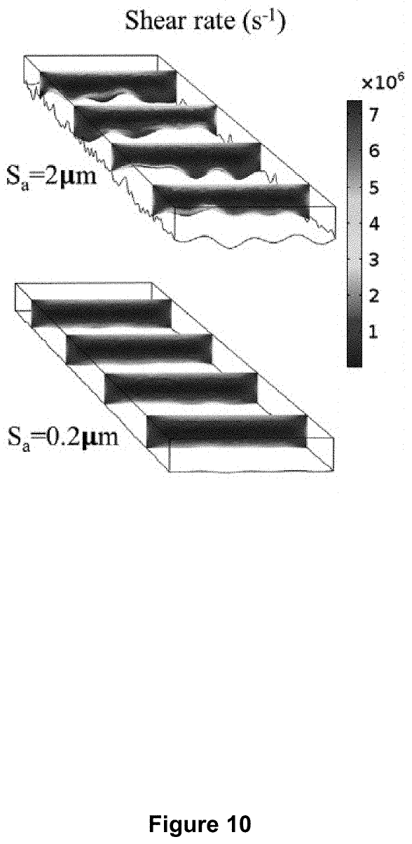

FIGS. 8-10 illustrate the velocity and shear rate distribution throughout the channels. As can be seen in the slice representation of velocity in FIG. 8, the microchannel with Sₐ of 2 μm has non-uniform fluid velocities along the width and length of the channels, however, by decreasing the roughness to 0.2 μm, the velocity became much more consistent across the channel. Furthermore, there is a striking difference in shear rate magnitudes between these two microchannels. FIGS. 9 and 10 demonstrate an uneven volumetric distribution of shear rate inside the rougher channel so that at some points close to the rough surface of the channel, shear rate reaches the maximum value of 1.4×10⁷ s⁻¹. Whereas the microchannel with the roughness of 0.2 μm has an almost uniform volumetric shear rate and there is no sharp rise in the shear rate at the rough surface. The shear rate also did not go over than 3.7×10⁶ s⁻¹ in the smoother channel.

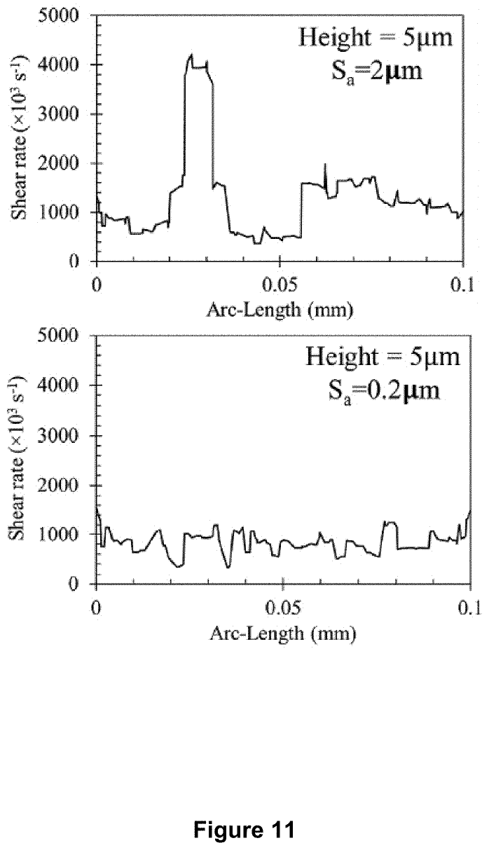

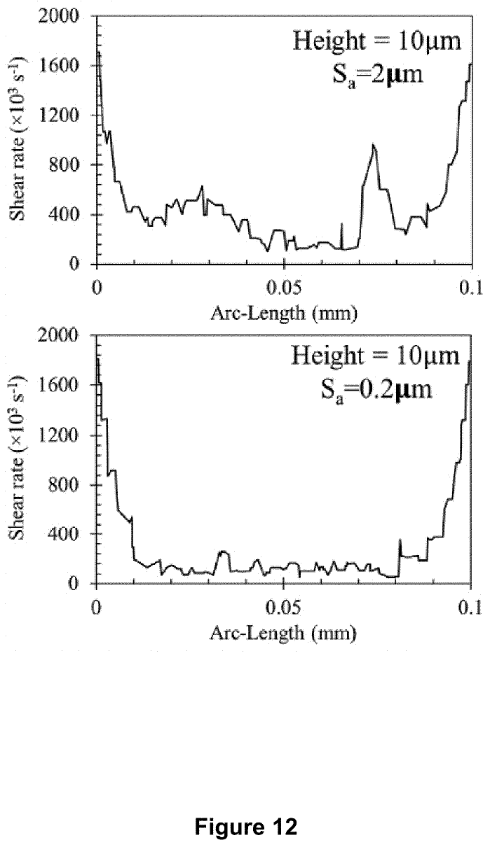

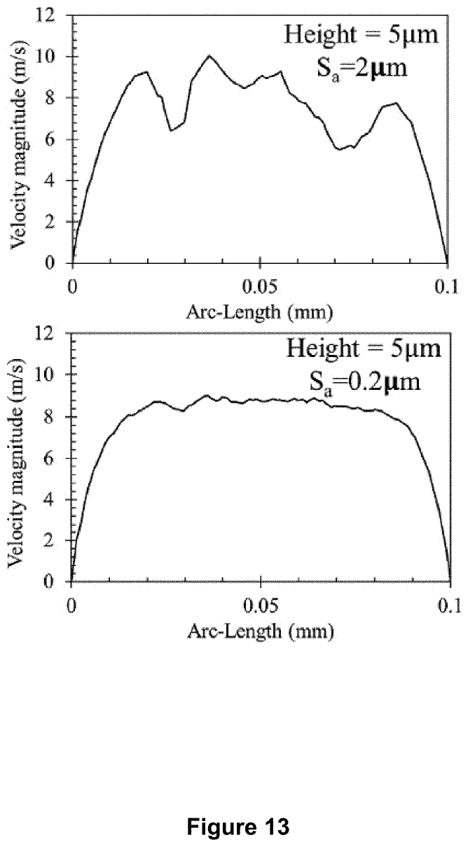

The changes in shear rate and velocity magnitudes along the channels' width were plotted in FIGS. 11-13. In these Figures, the lateral arc-lengths were located in the mid-length of the channels at two different heights of 5 μm and 10 μm above the rough surface's mean plane (FIG. 7; upper). FIG. 11 illustrates wide fluctuation in shear rate in the sample with Sₐ=2 μm such that at some regions, the shear rate increases fourfold and reaches 4000×10³ s⁻¹. By getting far from the rough surface (FIG. 12), although the roughness effect on shear rate decreases, there is still considerable fluctuation in shear rate. In comparison, the microchannel with Sₐ=0.2 μm exhibited much steadier shear rate along the width of the channel and the average of the shear rate was lower than the rougher channel. A similar trend can be seen in terms of the velocity variation plot (FIG. 13). Even at the height of 10 μm, the inconsistent velocity can be observed inside the rougher microchannel (FIG. 7; lower).

Having uniform shear rate and velocity magnitude may, for example, be a decisive factor in microfluidic devices especially when the effect of these parameters on biological entities is going to be investigated. For instance, in hemostasis assays, blood coagulation and clot formation rely heavily on the shear stress, and proteolysis of von Willebrand factor by ADAMTS13, in particular, is controlled by shear stress triggered by the blood.^{23,24,25} Consequently, it is advantageous to induce a precise range of shear rate throughout the microchannels so as to screen hemostasis on a chip.^{26,27}

### (e) Device Bonding Tests and Imaging Live Cells

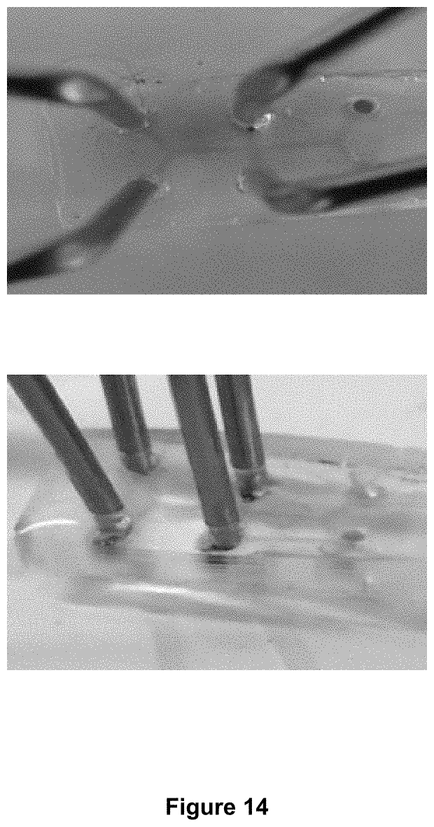

The viability of the fabricated smooth PDMS device was tested by bonding it to a flat layer of PDMS. This was done to confirm that the fabrication method would not interfere with the bonding process or the operation of the device. The two inlets and four outlets were cut from the device and connected to tubing. Water containing an orange dye was injected into the inlets under constant pressure. The flow-through was linear and controlled as seen in FIG. 14. The device was operated successfully under flow rates of up to 1 mm s⁻¹ and no leaking was observed. This shows that the present method to produce smooth PDMS channels does not interfere with device performance.

To further investigate the devices' optical clearance, cell media containing Human Umbilical Vein Endothelial Cells (HUVEC) was injected into both rough and smooth devices with a 1 μL min⁻¹ velocity. Visualization of cells within the channel was clearly seen. Moreover, the smooth channel provided excellent contrast for visualization of the cells compared to the contrast seen in the rough channel.

While the present application has been described with reference to what are presently considered to be the preferred examples, it is to be understood that the application is not limited to the disclosed examples. To the contrary, the present application is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR DOCUMENTS REFERRED TO IN THE APPLICATION

¹S. K. Sia, G. M. Whitesides, Microfluidic devices fabricated in Poly(dimethylsiloxane) for biological studies, Electrophoresis. 24 (2003) 3563-3576. doi:10.1002/elps.200305584.
²H. Andersson, A. van den Berg, Microfluidic devices for cellomics: a review, Sensors Actuators B Chem. 92 (2003) 315-325. doi:10.1016/50925-4005(03)00266-1.
³J. C. Baret, O. J. Miller, V. Taly, M. Ryckelynck, A. El-Harrak, L. Frenz, C. Rick, M. L. Samuels, J. B. Hutchison, J. J. Agresti, D. R. Link, D. A. Weitz, A. D. Griffiths, Fluorescence-activated droplet sorting (FADS): efficient microfluidic cell sorting based on enzymatic activity, Lab Chip. 9 (2009) 1850. doi:10.1039/b902504a.
⁴N. L. Jeon, S. K. W. Dertinger, D. T. Chiu, I. S. Choi, A. D. Stroock, G. M. Whitesides, Generation of Solution and Surface Gradients Using Microfluidic Systems, Langmuir. 16 (2000) 8311-8316. doi:10.1021/1a000600b.
⁵C. D. Chin, V. Linder, S. K. Sia, Commercialization of microfluidic point-of-care diagnostic devices, Lab Chip. 12 (2012) 2118. doi:10.1039/c21c21204h.
⁶D. Huh, B. D. Matthews, A. Mammoto, M. Montoya-Zavala, H. Y. Hsin, D. E. Ingber, Reconstituting Organ-Level Lung Functions on a Chip, Science. 328 (2010) 1662-1668. doi:10.1126/science.1188302.
⁷N. Bhattacharjee, A. Urrios, S. Kang, A. Folch, The upcoming 3D-printing revolution in microfluidics, Lab Chip. 16 (2016) 1720-1742. doi:10.1039/C6LC00163G.
⁸Y. Hwang, O. H. Paydar, R. N. Candler, 3D printed molds for non-planar PDMS microfluidic channels, Sensors Actuators A Phys. 226 (2015) 137-142. doi:10.1016/j.sna.2015.02.028.
⁹V. Saggiomo, A. H. Velders, Simple 3D Printed Scaffold-Removal Method for the Fabrication of Intricate Microfluidic Devices, Adv. Sci. 2 (2015) 1500125. doi:10.1002/advs.201500125.
¹⁰Y. Hwang, D. Seo, M. Roy, E. Han, R. N. Candler, S. Seo, Capillary Flow in PDMS Cylindrical Microfluidic Channel Using 3-D Printed Mold, J. Microelectromechanical Syst. 25 (2016) 238-240. doi:10.1109/JMEMS.2016.2521858.
¹¹D. C. Leslie, A. Waterhouse, J. B. Berthet, T. M. Valentin, A. L. Watters, A. Jain, P. Kim, B. D. Hatton, A. Nedder, K. Donovan, E. H. Super, C. Howell, C. P. Johnson, T. L. Vu, D. E. Bolgen, S. Rifai, A. R. Hansen, M. Aizenberg, M. Super, J. Aizenberg, Donald E Ingber, A bioinspired omniphobic surface coating on medical devices prevents thrombosis and biofouling, Nat. Biotechnol. 32 (2014) 1134-1140. doi:10.1038/nbt.3020.
¹²A. K. Epstein, T.-S. Wong, R. A. Belisle, E. M. Boggs, J. Aizenberg, Liquid-infused structured surfaces with exceptional anti-biofouling performance, Proc. Natl. Acad. Sci. U.S.A. 109 (2012) 13182-13187. doi:10.1073/pnas.1201973109.
¹³P. W. Wilson, W. Lu, H. Xu, P. Kim, M. J. Kreder, J. Alvarenga, J. Aizenberg, Inhibition of ice nucleation by slippery liquid-infused porous surfaces (SLIPS), Phys. Chem. Chem. Phys. 15 (2013) 581-585. doi:10.1039/C2CP43586A.
¹⁴X.-M. Li, D. Reinhoudt, M. Crego-Calama, What do we need for a superhydrophobic surface? A review on the recent progress in the preparation of superhydrophobic surfaces, Chem. Soc. Rev. 36 (2007) 1350-1368. doi:10.1039/b602486f. ¹⁵A. Tuteja, W. Choi, J. M. Mabry, G. H. Mckinley, R. E. Cohen, Robust omniphobic surfaces, PNAS. 105 (2008) 18200-18205. doi:10.1073?pnas.0804872105. ¹⁶H. Guo, P. Fuchs, K. Casdorff, B. Michen, M. Chanana, H. Hagendorfer, Y. E. Romanyuk, I. Burgert, Bio-Inspired Superhydrophobic and Omniphobic Wood Surfaces, Adv. Mater. Interfaces. 4 (2017) 1600289. doi:10.1002/admi.201600289.
¹⁷T. S. Wong, S. H. Kang, S. K. Y. Tang, E. J. Smythe, B. D. Hatton, A. Grinthal, J. Aizenberg, Bioinspired self-repairing slippery surfaces with pressure-stable omniphobicity, Nature. 477 (2011) 443-447. doi:10.1038/nature10447.
¹⁸L. Xiao, J. Li, S. Mieszkin, A. Di Fino, A. S. Clare, M. E. Callow, J. A. Callow, M. Grunze, A. Rosenhahn, P. A. Levkin, Slippery liquid-infused porous surfaces showing marine antibiofouling properties, ACS Appl. Mater. Interfaces. 5 (2013) 10074-10080. doi:10.1021/am402635p.
¹⁹P. Wang, Z. Lu, D. Zhang, Slippery liquid-infused porous surfaces fabricated on aluminum as a barrier to corrosion induced by sulfate reducing bacteria, Corros. Sci. 93 (2015) 159-166. doi:10.1016/j.corsci.2015.01.015.
²⁰J. L. Blin, M. J. Stébé, Perfluorodecalin Incorporation in Fluorinated Surfactant-Water System: Tailoring of Mesoporous Materials Pore Size, J. Phys. Chem. B. 108 (2004) 11399-11405. doi:10.1021/JP0493795.
²¹B. Sjodin, How to Generate Random Surfaces in COMSOL Multiphysics, (2017). https://www.comsol.com/blogs/how-to-generate-random-surfaces-in-comsol-multiphysics/ (accessed Aug. 30, 2017).
²²S. Uperaft, R. Fletcher, The rapid prototyping technologies, Assem. Autom. 23 (2003) 318-330. doi:10.1108/01445150310698634.
²³E. Gutierrez, B. G. Petrich, S. J. Shattil, M. H. Ginsberg, A. Groisman, A. Kasirer-Friede, Microfluidic devices for studies of shear-dependent platelet adhesion, Lab Chip. 8 (2008) 1486-95. doi:10.1039/b804795b.
²⁴E. Westein, A. D. Van Der Meer, M. J. E. Kuijpers, J. Frimat, A. Van Den Berg, Atherosclerotic geometries exacerbate pathological thrombus formation poststenosis in a von Willebrand factor-dependent manner, Proc. Natl. Acad. Sci. U.S.A. 110 (2012) 1357-1362. doi:10.1073/pnas.1209905110.
²⁵M. Li, N. A. Hotaling, D. N. Ku, C. R. Forest, Microfluidic thrombosis under multiple shear rates and antiplatelet therapy doses, PLoS One. 9 (2014) e82493. doi:10.1371/journal.pone.0082493.
²⁶L. Ting, S. Feghhi, A. Karchin, W. Tooley, N. J. White, Clot-On-A-Chip: A Microfluidic Device To Study Platelet Aggregation and Contractility Under Shear, Blood. 122 (2013) 2363.
²⁷T. V. Colace, G. W. Tormoen, O. J. T. McCarty, S. L. Diamond, Microfluidics and Coagulation Biology, Annu Rev Biomed Eng. 15 (2013) 283-303. doi:10.1146/annurev-bioeng-071812-152406.

TABLE 1
3D printer resolution.

| | | | X/Y | Layer | |
|---|---|---|---|---|---|
| | | | Resolution | Thickness | |
| Manufacturer | Model | Type | (dpi/μm) | (μm) | Ref |
| 3D Systems | Projet | Inkjet | 375/67 | 32 | 10 |
| | 3510SD | | | | |
| Stratasys | Object 24 | Inkjet | 600/42 | 28 | 10 |
| 3D Systems | Projet | Inkjet | 656/38 | 32 | Tested |
| | HD3000 | | | | |
| 3D Systems | Viper Sl | Stereolithography | 3300/7.6 | 2.5 | 10 |
| Z Rapid | SL200 | Stereolithography | 2500/10 | 0.2 | 10 |

1. A process for fabricating a molded object, the process comprising:
coating a mold with a layer comprising a lubricant-tethering group to obtain a tether-coated mold;
depositing a lubricant on the tether-coated mold to obtain a lubricant-infused mold (LIM);
depositing a molded object precursor into the LIM and solidifying to obtain the molded object; and
removing the molded object from the LIM.

2. The process of claim 1, wherein the layer comprising the lubricant-tethering group and the lubricant deposited thereon form an omniphobic surface and the lubricant-infused mold is an omniphobic lubricant-infused mold (OLIM).

3. The process of claim 2, wherein the layer comprising the lubricant-tethering group is a self-assembled monolayer (SAM) and the mold is coated with the SAM by a process comprising depositing a compound of the structure: 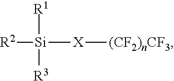
wherein
X is a single bond or is C₁₋₆alkylene;
n is an integer of from 0 to 12; and
R¹, R² and R³ are each independently a hydrolysable group.

4. The process of claim 3, wherein the deposition comprises chemical vapor deposition followed by curing at elevated temperature under air, R¹, R² and R³ are all Cl, X is —CH₂CH₂— and n is 5.

5. The process of claim 2, wherein the lubricant is a perfluorocarbon oil.

6. The process of claim 5, wherein the perfluorocarbon oil is perfluoroperhydrophenanthrene. The process of claim 3, wherein the mold comprises a silicone elastomer.

8. The process of claim 1, wherein the molded object comprises a silicone elastomer, the molded object precursor is a liquid-phase molded object precursor that is prepared by mixing a first composition comprising a liquid polydialkylsiloxane and a second composition comprising a curing agent, and the solidifying comprises curing at elevated temperature under air.

9. The process of claim 8, wherein the liquid polydialkylsiloxane is a dimethylvinylsiloxy-terminated polydimethylsiloxane.

10. The process of claim 1, wherein the mold has been fabricated by a process comprising 3D printing.

11. The process of claim 10, wherein the mold is a negative mold and the molded object is a positive mold.

12. The process of claim 11, wherein the process is for preparing a second molded object from the positive mold and the process further comprises:
optionally coating the positive mold with a layer comprising a demolding-promoting group to obtain a coated positive mold;
depositing a second molded object precursor into the optionally coated positive mold and solidifying to obtain the second molded object; and
removing the second molded object from the optionally coated positive mold.

13. The process of claim 12, wherein the layer comprising the demolding-promoting group is a second self-assembled monolayer (SAM) and the positive mold is coated with the second SAM by a process comprising depositing a compound of the structure: 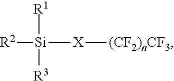
wherein
X is a single bond or is C₁₋₆alkylene;
n is an integer of from 0 to 12; and
R¹, R² and R³ are each independently a hydrolysable group.

14. The process of claim 13, wherein the deposition comprises chemical vapor deposition followed by curing at elevated temperature under air, R¹, R² and R³ are all Cl, X is —CH₂CH₂— and n is 5.

15. The process of claim 14, wherein the second molded object comprises a silicone elastomer, the second molded object precursor is a liquid-phase molded object precursor that is prepared by mixing a first part comprising a liquid polydialkylsiloxane and a second part comprising a curing agent, and the solidifying comprises curing at elevated temperature under air.

16. The process of claim 15, wherein the liquid polydialkylsiloxane is a dimethylvinylsiloxy-terminated polydimethylsiloxane.

17. The process of claim 12, wherein the negative mold comprises a low-resolution microstructure and the positive mold fabricated therefrom comprises a corresponding smooth-surfaced microstructure.

18. The process of claim 17, wherein the microstructure is a microchannel.

19. The process of claim 18, wherein the second molded object is for use as a component of a microfluidics device.

20. A lubricant-infused mold (LIM), the LIM comprising:
a mold;
a layer comprising a lubricant-tethering group coated on the mold; and
a lubricant tethered to the layer comprising the lubricant-tethering group.
